(19) United States
(12) Patent Application Publication
(10) Pub. No.: US 2024/0254975 A1
(43) Pub. Date: Aug. 1, 2024

(54) HEAT ENGINE SYSTEM AND METHOD

(71) Applicant: SMARTER ALLOYS INC., Cambridge (CA)

(72) Inventors: Mohammad Ibrahem KHAN, Cambridge (CA); Michael Lawrence KUNTZ, Cambridge (CA); Ben Kinh TAN, Cambridge (CA); Vickram Swarn Singh LAKHIAN, Cambridge (CA); Shahzad AHSAN, Cambridge (CA)

(21) Appl. No.: 18/289,603

(22) PCT Filed: May 9, 2022
(86) PCT No.: PCT/CA2022/050726

§ 371 Date: Nov. 6, 2023

Related U.S. Application Data
(60) Provisional application No. 63/185,480, filed on May 7, 2021.

(51) Int. Cl. F03G 7/06

(52) U.S. Cl. CPC F03G 7/063; F03G 7/0614

(57) ABSTRACT

A heat engine including at least one shape memory alloy (SMA) core that, when exposed to at least two different temperatures contracts and expands to generate mechanical motion which can then be transmitted to a generator.

### CROSS-REFERENCE TO OTHER APPLICATIONS

The present disclosure claims priority from U.S. Provisional Application No. 63/185,480 filed on May 7, 2021 which is hereby incorporated by reference.

### FIELD

The present disclosure relates generally to a heat engine. More particularly, the present disclosure relates to a system and method for converting heat into mechanical motion.

### BACKGROUND

Heat engines are constructs capable of converting heat to mechanical energy. Reversible heat engines are capable of using mechanical energy to drive heat flow and create a temperature gradient. The forward use case has applications wherever mechanical energy can be used, for example, for motion or movement of bodies (i.e. actuators, lifts, transportation), fluid flow (e.g. gas compressors and pumps), or mechanical energy storage (e.g. compressed air, springs, weights lifted to heights) or electrical generation. The reverse use case is most typically seen in refrigeration cycles and heat pumps, to drive a temperature difference and extract heat from a cold source or the like.

There are various conventional methods of converting heat into electrical energy but the ability to do so at low temperatures is an on-going problem in many industries, including the energy generation industry. In traditional power generation, heat is generated using the combustion of fuels to drive a heat engine, however, there remains significant energy content in exhaust flues that is not harnessed. For most power generation applications, it has been estimated that up to 65% of energy is lost. More specifically, up to 30-40% of energy is dissipated through active cooling (i.e. coolant), while 20-30% is lost through exhaust. A solution to allow the capture and use of this heat would be a significant leap in the reduction of greenhouse gases (GHG) by improving the efficiency of existing power sources and industrial or commercial processes by enabling the realization of novel clean power generating methods.

Over the years there have been various attempts to improve the operation of heat engines at lower temperatures, yet there remains an unmet need.

Alternatively, the reverse operation heat engine has a common overall design, with many potential uses. Typically, a refrigerant is used and operates through an evaporation-condensation cycle through a compressor and expansion valve to extract heat at low temperature at the evaporator, where the gaseous refrigerant is then compressed and passed to the condenser where the heat is extracted. This is true for heat pumps, refrigerators and industrial chillers. The refrigerant is carefully selected to tailor the operating performance to specific temperature ranges which are locked in at the time of manufacturing. Refrigerants are typically organic chemicals with high Global Warming Potentials (GWP), e.g. R410A (GWP=2,088), R134a (GWP=1,300). Furthermore, small refrigeration loads with low thermal mass result in the compressor cycling frequently, sometimes leading to pre-mature failure. There is a demand in laboratory equipment, consumer electronics, sporting goods and more for a robust reversible heat engine, capable of providing refrigeration, particularly for small loads.

The above information is presented as background information only to assist with an understanding of the present disclosure. No determination has been made, and no assertion is made, as to whether any of the above might be applicable as prior art with regard to the present disclosure.

Therefore, there is provided a novel heat engine system and method or an improved system and method for capturing and converting heat, and more specifically low temperature heat, to electrical energy.

### SUMMARY

In one aspect, there is provided a heat engine including at least one shape memory alloy (SMA) core; wherein when the at least one SMA core is exposed to at least two different temperatures, the SMA core expands and contracts during exposure to generate mechanical motion within the at least one SMA core.

In another aspect, the heat engine further includes a generator or linear alternator for capturing the mechanical motion and translating the mechanical motion into energy. In yet another aspect, the heat engine further includes a gearbox connecting the at least one SMA core to the generator. In yet a further aspect, the heat engine includes a hot supply for supplying a hot medium to the at least one SMA core; and a cold supply for supplying a cold medium to the at least one SMA core.

In an aspect, the at least one SMA core includes a SMA belt, SMA rods, SMA wires, SMA springs, SMA sheets or SMA in a foam form. In another aspect, the heat engine includes a reservoir for housing the at least one SMA core. In yet a further aspect, the at least one SMA core includes a pair of SMA cores. In yet another aspect, the reservoir includes a first section for housing a first SMA core and a second section for housing a second SMA core. In a further aspect, the first section includes an inlet connected to a hot supply for receiving a hot medium. In another aspect, the first and second sections each include a hot supply inlet valve for receiving a hot medium and a cold supply inlet valve for receiving a cold medium. In yet a further aspect, the heat engine includes a controller for filling the first section with the hot medium and the second section with the cold medium and then filling the first section with the cold medium and the second section with the hot medium.

In another aspect, the at least one SMA core is processed via multiple memory material technology. In a further aspect, the heat engine includes four SMA cores that are radially connected. In yet a further aspect, the heat engine includes a set of four reservoirs for housing each of the four SMA cores, each of the set of reservoirs including at least one inlet valve for receiving fluid for heating or cooling the four SMA cores. In yet another aspect, the heat engine includes an inlet valve for one of the reservoirs is connected to an outlet valve of another reservoir.

In a further aspect, the at least one SMA core includes a set of three bearings in a delta configuration; a reservoir for housing two of the set of three bearings; and a SMA belt wrapped around the set of three bearings; wherein the two of the set of three bearings are exposed to a different temperature than the other of the set of three bearings. In another aspect, the heat engine includes an idler pulley located connected to the other of the set of three bearings and wherein the SMA belt wraps around the set of three bearings and the idler pulley. In yet another aspect, the idler pulley includes two pulleys of unequal radii. In yet another aspect, the at least one SMA core includes at least one bundle of SMA wires. In a further aspect, ends of the SMA wires are crimped or swaged with SMA material. In yet another aspect, the ends of the SMA wires are locally heat treated before or after being crimped or swaged. In another aspect, the heat engine is integrated with a valve that is actuated by the at least one SMA core. In another aspect, the heat engine includes at least one valve actuated by a hydraulic or pneumatic system charged directly by SMA actuation.

In another aspect of the disclosure, there is provided a refrigeration device including at least one shape memory alloy (SMA) core; wherein when the at least one SMA core is placed under strain to induce the exothermic phase transformation and then released from strain to undergo an endothermic phase transformation.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIGS. 1A and 1B are schematic diagrams of multiple memory material processes;

FIG. 2 is a photo of a heat engine according to an embodiment;

FIG. 3 is an example of a temperature gradient related to the heat engine of FIG. 2;

FIG. 4 is a schematic diagram of a heat engine according to an embodiment;

FIGS. 5A and 5B are schematic diagrams of a mesh-type construction for the heat engine according to an embodiment;

FIG. 6 is a schematic diagram of a heat engine within an operational environment;

FIGS. 7A, 7B and 7C are schematic diagrams showing one embodiment of operation for an antagonistic configuration according to an embodiment;

FIG. 8 is a schematic diagram of a delta configuration heat engine according to an embodiment;

FIG. 9 is a schematic diagram of an embodiment of a delta configuration heat engine with an idler pulley;

FIGS. 10A, 10B and 10C are schematic diagrams of an embodiment of a heat engine with multiple cores radially connected a;

FIGS. 11A and 11B are schematic diagrams of cantilever heat engine configuration according to an embodiment;

FIGS. 12A, 12B and 12C are schematic diagrams showing a variable timing heat engine configuration according to an embodiment;

FIGS. 13A, 13B and 13C are schematic diagrams of components of another embodiment of a heat engine set up;

FIG. 14 is a schematic diagram of a spring-loaded hinge valve assembly;

FIG. 15 is a schematic diagram of a rolling valve assembly;

FIGS. 16A and 16B are schematic diagrams of a deadweight biasing mechanism according to an embodiment;

FIGS. 17A and 17B are schematic diagrams of a spring biasing mechanism according to an embodiment;

FIGS. 18A and 18B are schematic diagrams of a crankshaft conversion mechanism according to an embodiment;

FIGS. 19A and 19B are schematic diagrams of a V-shaped crankshaft conversion mechanism according to an embodiment;

FIG. 20 is a schematic diagram of a leverage mechanism with heat engine for increasing the stroke according to an embodiment;

FIG. 21 is a schematic of a valve rigidly connected to a piston according to an embodiment;

FIGS. 22A, 22B, 22C and 22D illustrate one embodiment of operation of FIG. 21 according to an embodiment;

FIG. 23 is a perspective view of a three-way valve configuration according to an embodiment;

FIG. 24 illustrates one embodiment of operation of the valve of FIG. 23 according to an embodiment;

FIG. 25 is a schematic diagram of the valve of FIG. 23 incorporated on multiple cores according to an embodiment;

FIG. 26 is a schematic diagram of an SMA-based compressor according to an embodiment;

FIG. 27 is a schematic diagram of one embodiment of operation of an SMA reverse heat engine according to an embodiment; and

FIG. 28 is a schematic diagram of an implementation of FIG. 27 according to an embodiment.

### DETAILED DESCRIPTION

The following description with reference to the accompanying drawings is provided to assist in understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used to enable a clear and consistent understanding. Accordingly, it should be apparent to those skilled in the art that the following description of embodiments is provided for illustration purpose only and not for the purpose of limiting the disclosure as defined by the appended claims and their equivalents.

Generally, the present disclosure provides a system and method of heat engine technology that captures heat and converts it into mechanical energy (sometimes referred to as a “forward mode”). The heat engine of the disclosure is also able to operate in reverse, and use mechanical motion to create a temperature differential, as in a refrigerator (sometimes referred to as a “reverse mode”).

In some embodiments, the heat engine is enabled by, or includes, a shape memory alloy (SMA) core that may be processed with Multiple Memory Material (MMM) technology, such as described in, for example U.S. Pat. No. 9,186,853, granted Nov. 17, 2015 which is hereby incorporated by reference. An SMA undergoes a solid-solid material phase change at specific temperatures, depending on its material processing history. In the forward operating mode or forward mode, the SMA core has the capability of absorbing heat (endothermic phase transformation) or releasing energy (exothermic phase transformation) at discrete temperatures, either naturally occurring or programmed using MMM technology.

This allows for absorbed heat to be converted into mechanical motion, which may be used for a secondary purpose, e.g. to drive a generator to produce electricity. In one embodiment of a heat engine described herein, the heat engine can be tuned such that the SMA can undergo a phase transformation, for example, with a temperature below 90° C. and operate with a temperature differential of about 15° C. or greater. In other words, with an ambient temperature of 25° C., an embodiment of the disclosure may extract energy from a source that is at approximately 40° C. or higher. The exact temperature differential can be tuned to be larger or smaller through the use of MMM technology, thermomechanical processing or altering the composition of the SMA (e.g. NiTi, CuNiTi, AlNiTi, NiTiHf, etc.). In the reverse direction, elongating the material to experience a predetermined level of mechanical strain can induce this same endothermic phase change at a lower temperature which allows for heat extraction in a temperature range of about 150° ° C. to about 600° C.

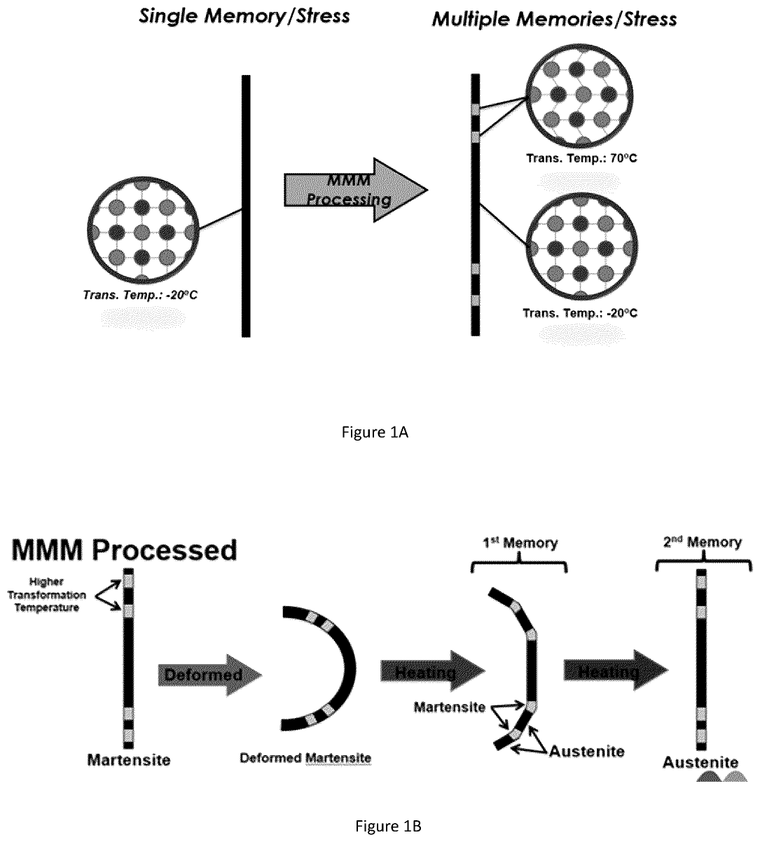

Examples of multiple memory material technology or processing are illustrated in FIGS. 1A and 1B. Multiple memory material processing allows for the precise tuning of local transformation temperatures of SMAs. This allows multiple transformation temperatures to be utilized for SMAs resulting in dynamic response at distinct temperatures. MMM technology, or processing, may be seen as a method for applying energy to a local area of a shape memory material to adjust the local structure and chemistry. This provides one or more additional transformation temperatures and modified pseudo-elastic properties of the treated local area of the SMA. The remaining unaffected SMA material still exhibits its original functional properties. Hence, additional memories can be embedded into a monolithic SMA component or material, which in turn enables additional functionality. This makes it possible to fabricate a monolithic SMA that can operate passively in a wide range of temperatures.

In operation, a heat engine operating in the forward direction may have the heat applied in numerous possible ways. The heat may be applied, for example, as a hot fluid (gas or liquid), via radiation (from a laser, focussed light, infrared heating, etc.) or through electric heating (indirectly through heating elements, or directly through joule heating). The heat source, or supply, may also come from completely renewable sources. Generally speaking, the heat engine can operate with any hot and cold source or supply. Although discussed as being a fluid below, it is understood that the heat and/or cold may be applied in different manners and mediums. One embodiment may include capturing heat from geothermal heat sources, or concentrating solar radiation to be used as the primary energy source for the heat engine.

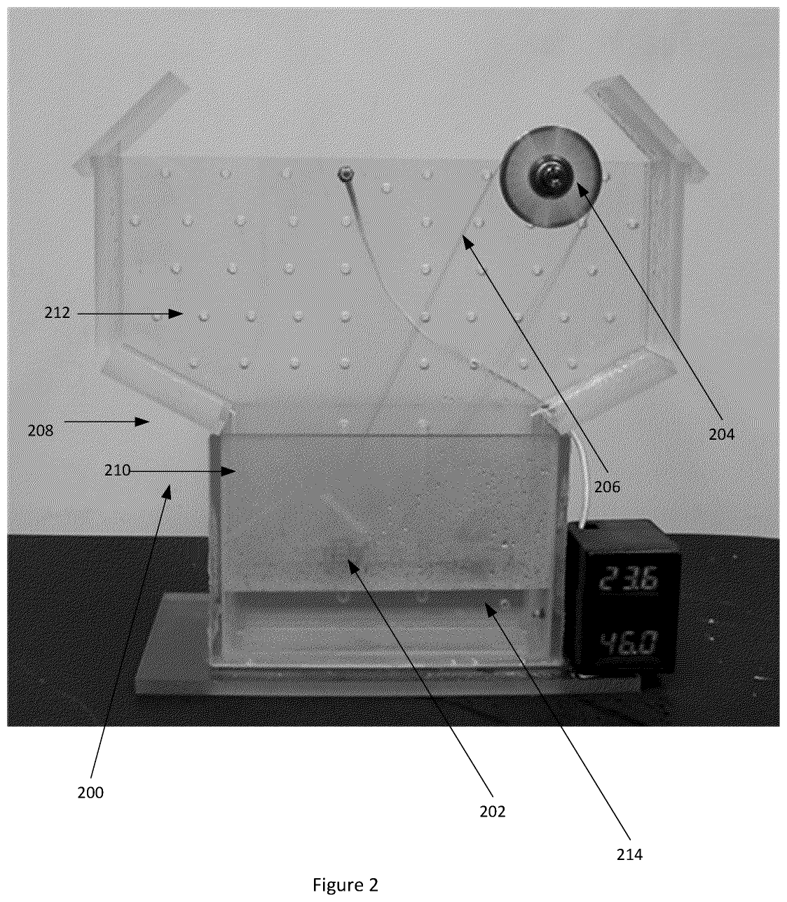

FIG. 2 illustrates an embodiment of a heat engine in the forward application. In the current embodiment, the design of the heat engine is intended to allow it to be easily integrated into existing facilities. In one embodiment, it can be integrated in-situ with an effluent heat source, therefore limiting disruption to normal operation.

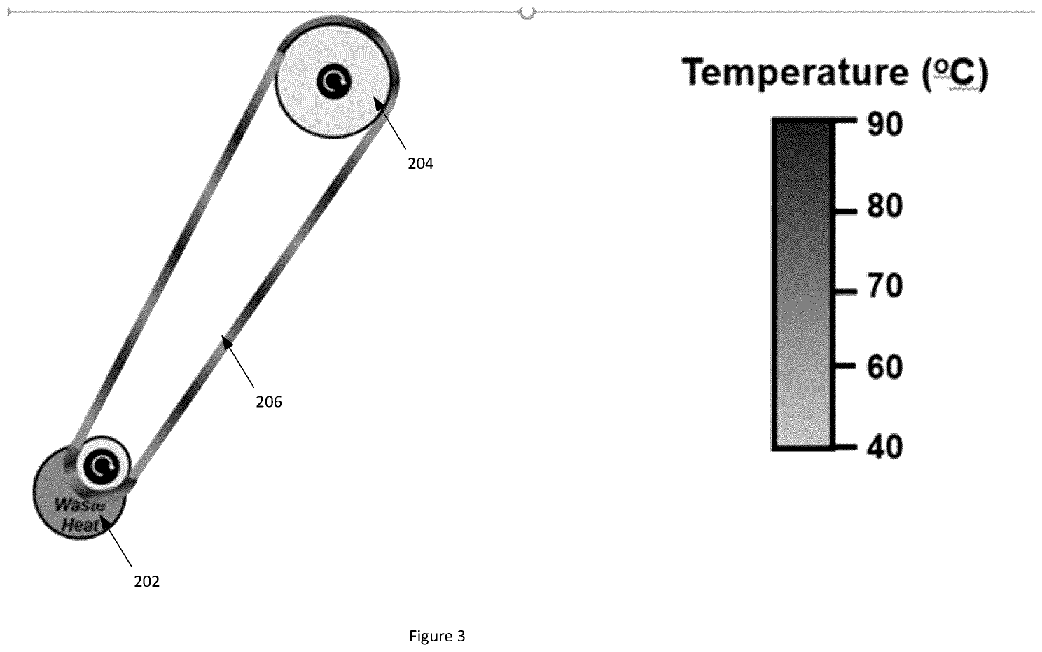

In the embodiment of FIG. 2, the heat engine 200 includes two wheels, seen as a lower wheel 202 and upper wheel 204, connected by a band 206 (which can also take the form of a wire) of SMA which is processed with MMM technology. In some embodiments, the band may not be processed with MMM technology. The heat engine 200 further includes a housing 208 including a lower liquid container portion 210 and a perforated upper portion 212 (although the upper portion 212 does not have to be perforated. The lower wheel 202 is submerged in a heat source fluid medium 214 located within the lower liquid container portion 210 and the upper wheel 204 is mounted to a wall of the upper portion 212. A temperature of the upper wheel 204 is lower compared with the temperature of the heat source fluid medium 214. In the current embodiment, the upper wheel 204 is at ambient temperature. Thus, the two wheels 202 and 204 (and the band 206) experience a temperature differential between the lower 202 and upper wheel 204, as schematically illustrated in FIG. 3.

As shown in FIG. 3, a temperature scale is provided with a darker shading reflecting a higher temperature and a lighter shading representing a lower temperature. As can be seen, as the band 206 travels between the two wheels 202 and 204, the band 206 experiences different temperatures.

The heat engine and SMA material of the band 206 can be configured according to the range of operating temperatures desired. In one embodiment, the heat engine is configured to operate as long as there is a temperature difference equal to, or greater than, that of the different phases in the SMA.

The SMA band can be processed to embed multiple memories (i.e. predetermined transformation temperatures via MMM technology or processing) and alter pseudo-elastic properties at discrete temperatures of different portions of the SMA band. As the temperature of the SMA band changes (as it moves between the two wheels), potentially passing through several transformation temperatures, each treated site will change shape at its respective transformation temperature. The transformation zone area can be as small as a few microns in width with multiple zones, each having a discrete transformation temperature, as shown in FIGS. 1A and 1B. Furthermore, embedding these zones side by side in a monolithic SMA actuator, wire, band or core, can allow for a unique and dynamic actuation in response to changing temperature.

In the specific embodiment of the heat engine of FIG. 2, the heat engine 200 has continued operation in the forward direction with a temperature heat source fluid medium 208 (or lower wheel 202) of 40° C. and ambient temperature, or temperature of the upper wheel 204, near 25° C. resulting in a temperature differential of about 15° C. In this embodiment, the cycle life for the SMA band when processed with the MMM technology increased 4X when compared to a conventional SMA band without MMM processing. This preliminary data is a strong indication that the MMM processed band of the disclosure will enable more efficient and/or effective operation in this embodiment of a heat engine.

In some embodiments, the heat engine may provide an increase in process efficiency by capturing low grade waste heat (LGWH) in addition to higher grade waste heat (generally considered heat at temperatures above 250° C.). This may then lower energy consumption and reduce carbon emissions, immediately benefiting the user of the heat engine.

In some embodiments, the heat engine may be useful in processes which emit quantities of heat, regardless of temperature, that have an existing need to increase their energy efficiency. Traditionally, power generation plants are a rich source of waste heat, including LGWH, and appreciate the need to reduce greenhouse gas emissions. As most conventional power plants use fossil fuels to generate electricity, increasing the efficiency of power plants by utilizing the heat engine may reduce CO₂ emissions. In some setups or designs, the heat engine may be attached or mounted to any heat source within the plant, as shown for example in the schematic of FIG. 4.

Aside from energy producers, there are numerous sources of heat, including LGWH, currently available including, for example, industrial processes, computer services, space heating and cooling, automotive vehicles, and marine vehicles, among others. It is expected that embodiments of the disclosure can also be adapted to other sectors as well.

At present, in conventional power plants, it is conservatively estimated that nearly 30% of the potential maximum power output is lost in LGWH. About 30 Gt CO₂ is emitted globally, of which 42% is from power plants generating electricity. Hence 12.6 Gt CO₂ is emitted globally for the production of electricity, of which approximately 3.8 Gt CO₂ (30%) is likely due to low grade waste heat losses. If embodiments of the heat engine described herein were, for example only, 25% efficient, then nearly 1 Gt CO₂ could be offset if implemented in all power plants. This would account for 3.3% of all CO₂ emissions if 100% adoption is achieved.

In one example, the heat engine of the disclosure may output 10 kW. Continuous operation for one year would produce 87,600 kWh of electricity, which, using the EPA emission factor (0.00082 tons CO₂/kWh), is calculated to otherwise emit 72 tons CO₂ eq/yr through conventional power plants.

Some additional economic benefits may also be realized with such the system of the disclosure. First, the removal of heat from a system is often a cost which is incurred by most power plants (via, for example, cooling/water towers). This cost may now turn into a revenue stream by use of an appropriate heat engine.

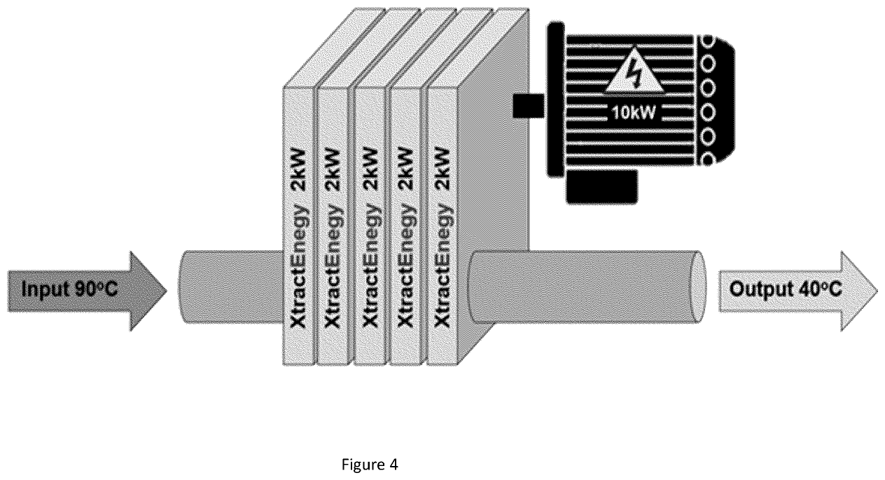

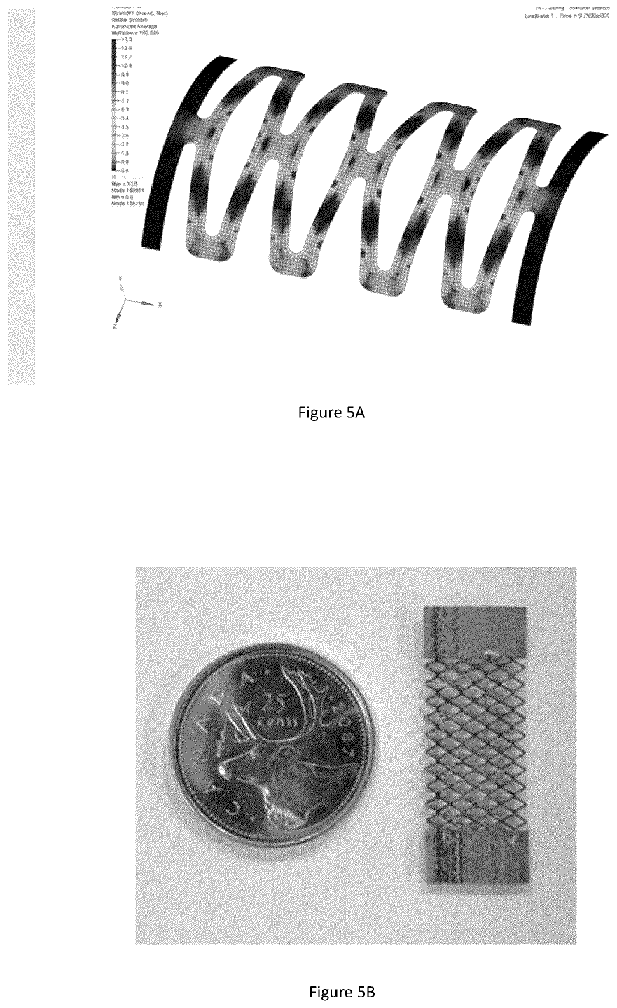

In another embodiment, the SMA band used in the heat engine may have a mesh-like configuration, such as that shown in FIGS. 5A and 5B, or the like. Having a mesh-like structure may allow the band to attach to a gear or the like on the wheel used within the heat engine to provide a stronger/non-slipping contact between the band and the wheel.

In an embodiment, the band may have a different treatment on the outer side compared to the inner side whereby the outer side of the band transforms at a different temperature than the inner side of the band which allows for the heat engine to continue operation at a wider range of temperature differentials.

In some embodiments of the SMA core, the band may be solid, where slippage is less of a concern, to maximize, or increase the amount of material and improve energy extraction. In this embodiment, each face, or side of the band may also have different treatment through MMM processing.

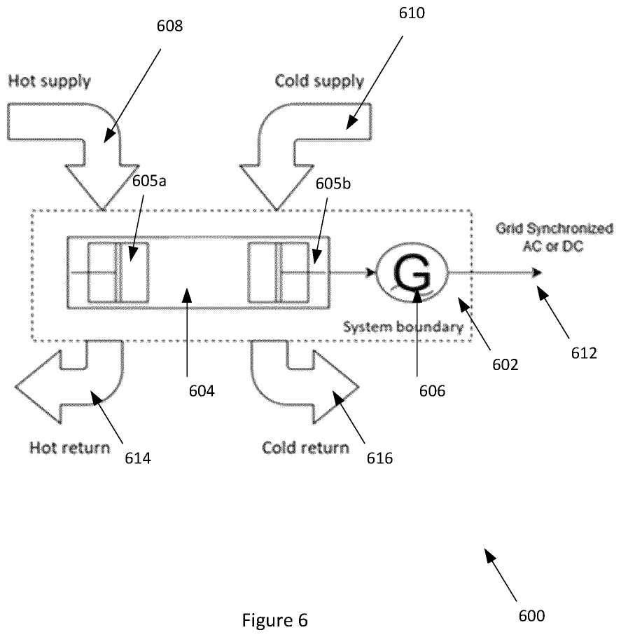

FIG. 6 illustrates a schematic architecture for an energy recovery device operating as a forward heat engine according to embodiments herein. The energy recovery device 600 includes an engine 602 driven by a shape memory alloy portion 604 (which in the current embodiment includes a first SMA core 605a and a second SMA core 605b) and a generator 606 that utilizes the mechanical motion generated from the shape memory alloy portion 604 to create electricity. The inputs to the device 600 include a hot source or supply 608 (i.e. heat in the form of a fluid such as liquid or gas or in the form of direct radiation) and a cold source or supply 610 (in the form of a fluid such as liquid). Depending on the environmental conditions, the cold supply 610 may be ambient air or some other freely available supply at a lower temperature relative to the hot supply 608. The outputs include clean electricity 612 (DC or AC, typically synchronized to the grid), a hot return 614 and a cold return 616. In an alternative design, the hot return 614 and cold return 616 may be combined to supply a single return source that results from the mixing of both the hot supply 608 and cold supply 610 after going through the engine 602. The engine 602 may include a single core or multiple cores. Multiple embodiments of the energy recovery device 600 may be implemented in parallel or series to the heat source. Furthermore, each device may embody a different SMA configuration within its core.

As examples, a heat engine having multiple cores may function as follows:
(a) Two cores 605 working antagonistically, while one is supplied by hot supply 606 and the other supplied by the cold supply 608 to cause the cores to contract and expand, respectively, each biasing the other as the cycle alternates and repeats itself.
(b) Two or more cores 605 working in parallel to increase the capacity of the system to increase heat throughput and produce more energy per cycle. In this case, modularity may allow the system to be customizable to virtually any size, given adequate space to house the system.
(c) Two or more cores 605 cascading in series, such that once the hot supply 606 exits the first core 605, it will enter the next core 605, at a slightly lower temperature, and continue to pass through each of the sequential cores 605 until the maximum, or a high, amount of energy is recovered to increase the efficiency of the system.

In an alternative embodiment, the energy recovery device (forward operating heat engine) 600 may incorporate apparatus for storing energy, such as, but not limited to, a water storage tank, flywheel, capacitor bank, or battery, to provide a continuous energy source if the engine is intermittent or to store energy for longer periods of time such that electricity can be used at a desired time (i.e. during peak demand).

In one example embodiment of the device, the engine 602 configuration creates reciprocating motion from the SMA core 604.

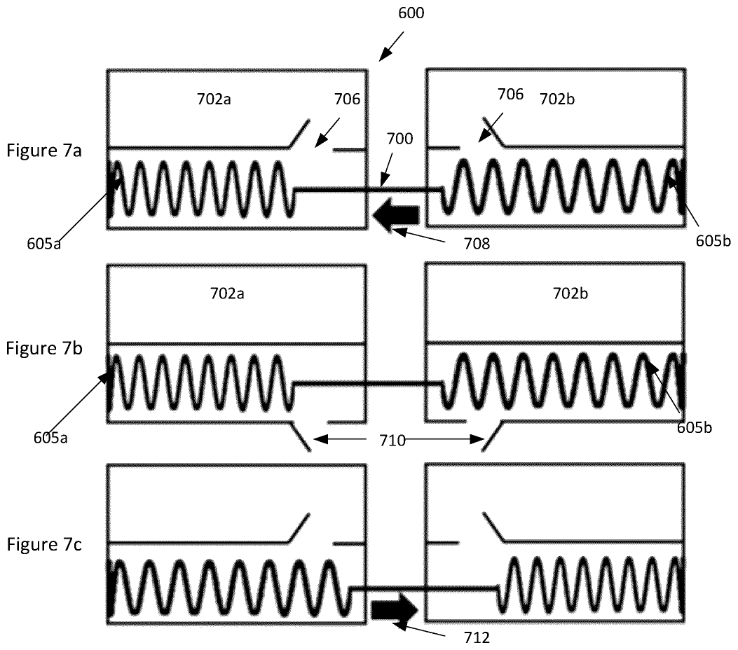

FIGS. 7a to 7c are schematic diagrams showing one embodiment of operation for the apparatus or heat engine of FIG. 6. The heat engine 600 includes two SMA cores 605a and 605b working antagonistically. The two cores 605a and 605b are connected to each other along a central axis 700 in line with the direction of motion.

In this embodiment, each of the cores 605 is located within a reservoir 702 that is connected to both the hot supply 608 and the cold supply 610 via separate hot and cold supply reservoir inlet valves 706. In the current embodiment, only one inlet valve 706 is seen for each reservoir, however, design of a reservoir having two or more inlet valves for receiving the hot and cold supply will be understood.

In operation, the reservoir 702a associated with the first core 605a is filled by the hot supply 608 (via the hot reservoir intake valve) while the reservoir 702b associated with the second core 605b is filled by the cold supply 610 via the cold reservoir intake valve (FIG. 7A). The first core 605a will contract as it undergoes an endothermic phase transformation to austenite and the second core 605b will expand as it undergoes an exothermic phase transformation to martensite. This causes motion towards the first core 605a in the direction (arrow 708) of the central axis.

The fluids from the hot supply 608 and cold supply 610 are then evacuated from the respective cores 605 (or reservoirs 702) via outlet valves 710 in each reservoir 702 (FIG. 7B). While the outlet valves 710 are open, the inlet valves 706 are closed, and the upper portions of the reservoirs 702 fill with the hot supply 608 and cold supply 610 depending on how the heat engine is designed. The cycle timing is optimized or designed such that the reservoirs 702 fill at a rate equivalent to the evacuation through the outlet valves 710.

Next, the outlet valves 710 close and the inlet valves 706 open (FIG. 7C). The cold reservoir inlet valve 706 connected to the first core 605a (that is in the hot phase) opens and the hot reservoir inlet valve 706 connected to the second core 605b (that is in the cold phase) opens. The first core 605a will expand as it undergoes an endothermic phase transformation to the cold phase and the second core 605b will contract as it undergoes an exothermic phase transformation to the hot phase. This causes motion towards the second core 605b in the direction ((arrow 712) of the central axis. The fluids from the hot supply 608 and cold supply 610 are then evacuated from the respective cores, similar to FIG. 7B, and the cycle continuously repeats alternating between hot and cold for each of the reservoirs. Design of the engine with respect to the reservoirs and the number of intake valves to enable alternate filling of the reservoirs (for alternating heating and cooling of the cores) can be done in any number of ways.

In some embodiments, the hot and cold supply and associated valving may be directly connected to the core, obviating the need for a reservoir.

In some embodiments, the valve switching timing may be directly linked to the position of the actuating core to optimize, or improve, switching time with the power stroke. In other embodiments, the valve switching timing can be optimized, or determined, through control timing algorithms for optimal power output.

In some embodiments, the cores can be insulated internally with material with low thermal mass and low conductivity, to minimize, or reduce, losses to the walls from fluid, or water, exchange between hot and cold cycles, and to occupy any dead space near the reservoir wall to reduce water volume. This can serve to improve efficiency.

In some embodiments, the central axis may be parallel to the ground on which the engine 600 sits (i.e. horizontal orientation as is suggested from FIG. 7), or it may be perpendicular to the ground (i.e. vertical orientation with one core on top of the other).

In some embodiments, the SMA material may take the shape of straight wires, springs, rods, or plates. The material may be solid of porous and operate in either tension or compression

In embodiments with springs, there may be a concentric rod axially mounted on the interior of the center of each spring where the rod may occupy volume and minimize, or reduce, the amount of volume of the hot and cold fluids. In some embodiments, the rod is manufactured from a material with low thermal mass and thermal conductivity e.g. a plastic foam. Another embodiment would have the concentric rod interior to the spring as the outlet for the hot supply 608 and cold supply 610.

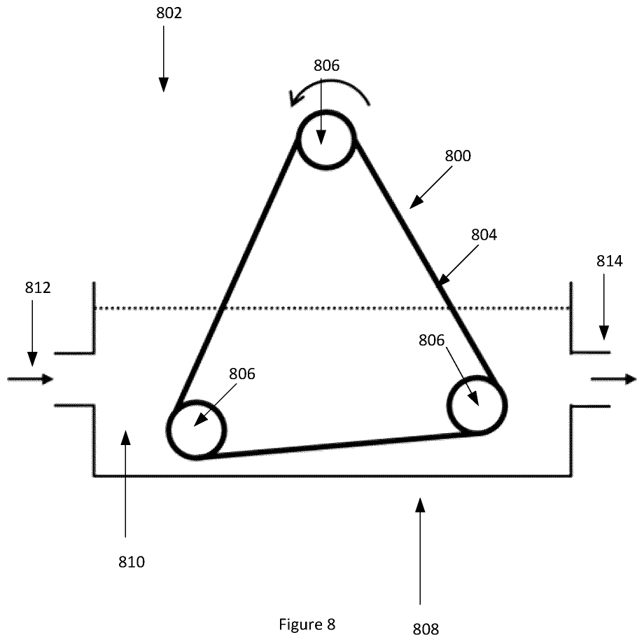

In another embodiment, as shown in FIG. 8, the engine configuration may create rotary motion from the SMA core 800.

FIG. 8 discloses a simplified schematic for an engine 802 that includes a single core 800 in a delta configuration. The SMA (which may or may not be MMM processed) acts as a belt 804 wrapped around three bearings 806 in a delta formation. The spacing of the bearings 806 and length of the SMA belt 804 are such that when the SMA belt 804 is wrapped around the bearings 804, it is pre-strained to stretch the material.

The delta formation is contained within a reservoir 808 such that at least one of the bearings is directly interfacing with a fluid 810, or fluid stream. The reservoir 808 includes an inlet 812 and an outlet 814, with the top of the reservoir 808 either partially or fully open such that at least one of the bearings 806 is housed within the reservoir 808 but not submerged in the fluid 810. In the current embodiment, the two bearings 806 at the base of the delta configuration are secured to the reservoir 808 within the fluid 810 so that they can be exposed to the temperatures of the fluid 810. The conditions outside of the fluid 810 are such that the SMA belt 804 is in its martensite phase at a lower temperature than the temperature of the fluid 810.

In use, the inlet 812 supplies the reservoir 808 with a fluid medium from a hot, or heat, supply causing the portion of the SMA belt 804 submerged in the reservoir 808 to undergo a phase transformation to austenite and contract, resulting in rotation of the SMA belt 804 about the bearings 806.

In another embodiment, the SMA belt 804 may be wrapped around two bearings 806 rather than three, however, the additional bearing 806 in the current embodiment allows for more material to be in contact with the fluid medium 810 from the hot supply, maximizing, or increasing, the energy output. In this case, the fluid from the hot supply passes continuously through the reservoir 808 from the inlet 812 to the outlet 814, though in an alternative design there may be an inlet valve or outlet valve, or both, to reduce the rate at which the fluid from the hot supply passes through the system to maximize, or increase, energy extraction. If valves are incorporated, a buffer tank may be included between the inlet and the valve to store the fluid from the hot supply and avoid wasting potential energy.

Similar to the embodiment shown in FIG. 8, FIG. 9 illustrates an alternative configuration of a delta engine 900. The engine 900 incorporates an idler pulley assembly 902 in the center of the delta formation. The idler pulley assembly 902 includes two pulleys 904a and 904b with unequal radii. The SMA belt 906 loops around the delta configuration, connecting to both pulleys 904 in the idler pulley assembly 902. The difference in radii creates a slight difference in the linear speed of the SMA belt 906 as it goes around the idler pulley 902, resulting in pretension to drive the system.

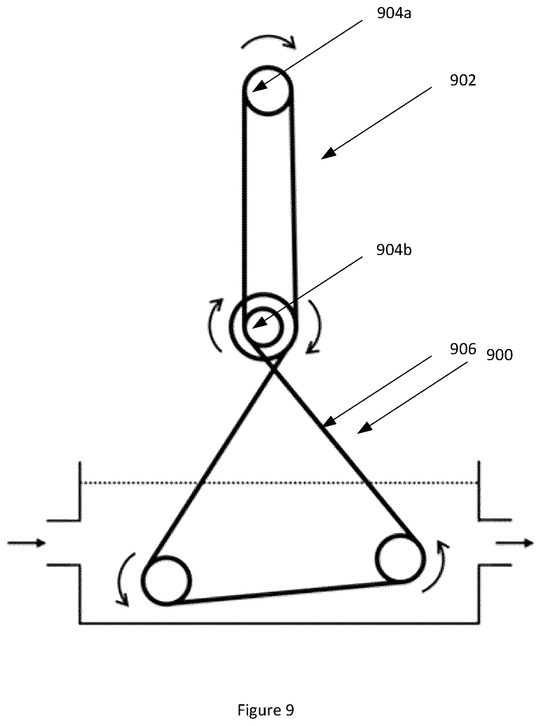

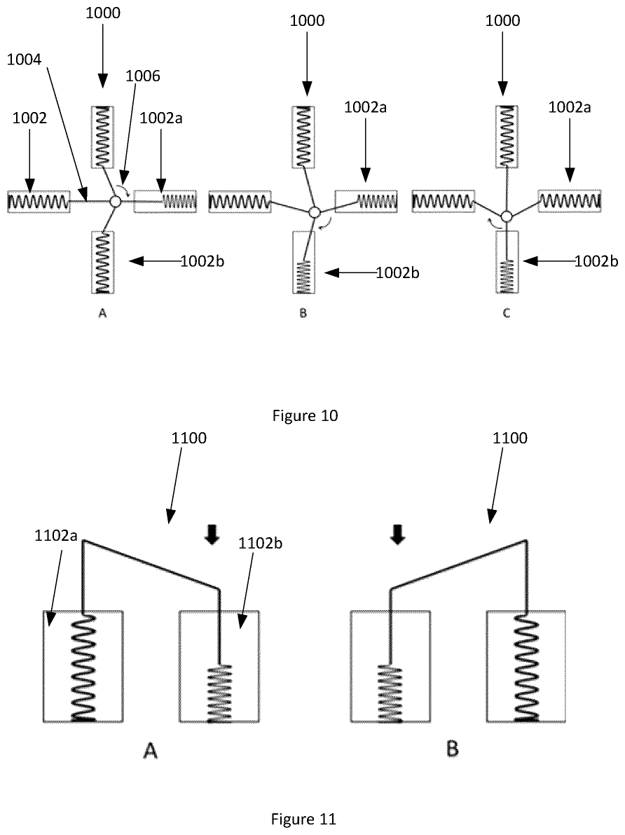

FIG. 10 illustrates another embodiment of an engine 1000 that creates, or generates, rotary motion which may then be stored. In this case, four SMA cores 1002 are connected radially by connecting rods 1004 forming a radial drive 1006 in the center where each core 1002 acts as a cylinder and piston. Each core 1002 is connected to a hot supply and cold supply (not shown), and each individual core 1002 may operate in the same manner as that described for FIG. 7 (valves controlling the supply of either hot or cold fluid medium to each core, with each operating independently). In some cases, the timing is synchronized such that each core 1002 is sequentially filled with fluid from the hot supply.

FIG. 10A, shows the start of the cycle, where one core 1002a is exposed to the fluid from the hot supply, causing the SMA in the core 1002a to contract, thereby pulling the radial drive 1006 towards the hot core 1002a. Next (FIG. 10B), the core 1002b adjacent to the first core 1002a is exposed to the fluid from the hot supply while the first core 1002 is flushed with fluid from the cold supply, either at the same time as the fluid from the hot supply is supplied to the second core 1002b or shortly thereafter, causing the radial drive 1006 to rotate to an intermediary position between the two cores 1002a and 1002b. Once the first core 1002a is completely cooled (FIG. 10C), the radial drive 1006 rotates further towards the second core 1002b.

This cycle continues for the remainder of the cores 1002 and repeats itself continuously, with one full rotation of the radial drive 1006 accomplished by supplying hot and cold sources to each of the four cores 1002 sequentially, resulting in a continuous rotary motion.

In another embodiment of this design, not all four SMA cores are actuated at the same temperature. The hot water source may flow sequentially from one core to the next, where each successive core has a lower transition temperature to extract more energy per cycle and improve efficiency.

In an alternative, the radial drive 1006 may be static, and the outer assembly of cores 1002 may rotate to create the continuous rotary motion with a single hot and cold inlet.

FIG. 11 illustrates another embodiment of a forward operating engine 1100 configuration that creates, or generates, a cantilever motion. In this embodiment, the engine 1100 includes two cores 1102a and 1102b. In one embodiment, the cores may operate in a similar manner to the method taught with respect to FIG. 7, however they are oriented such that the central axis of each core 1102 is parallel to one another and connected by a cantilever 1104. While one core 1102a is supplied with heat, such as in the form of a hot fluid, or hot fluid medium from a hot source or supply (not shown), the other is supplied with a cooling fluid, or cooling fluid medium from a cold supply or source (not shown), continuously alternating to drive the cantilever motion.

In one example of operation, in FIG. 11A, the core 1102a on the left is supplied with fluid from the cold supply and the core 1102b on the right is supplied with a fluid by the hot source, causing the cantilever to pivot clockwise towards the right core 1102b. In FIG. 11B, the inputs from the hot and cold supplies are flipped, causing the cantilever to pivot counter-clockwise towards the left core 1102a. The rotary motion at the pivot point is may be used to drive a generator or may be stored. In other embodiments, the cores 1102 may be connected to the cantilever on the same side (as shown), resulting in a pulling in one direction to create the cantilever motion, or the cores 1102 may be connected to the cantilever on opposite sides, resulting in each core pulling the cantilever in the opposite direction from either end. The mechanical motion may then be translated into energy for alternative use.

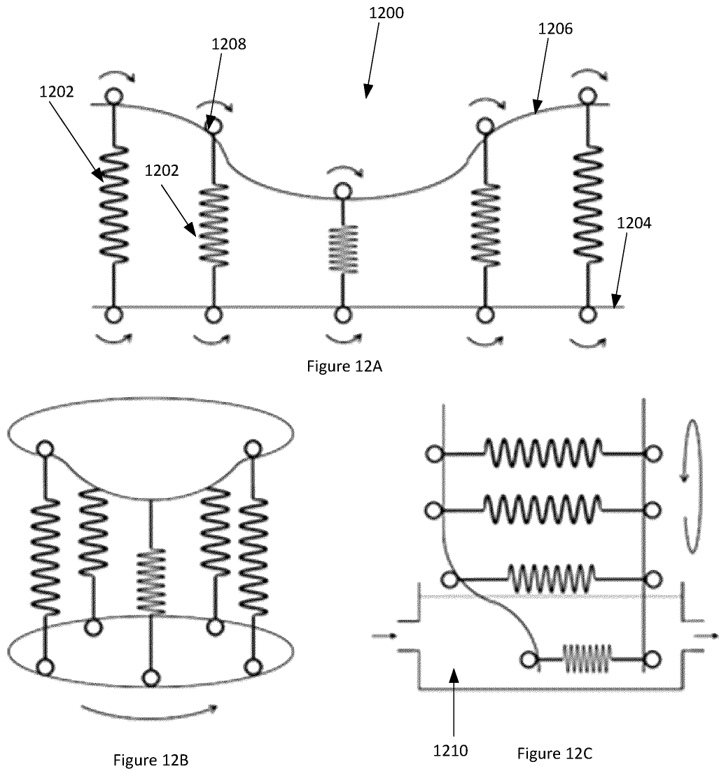

In another embodiment, as shown in FIGS. 12A to 12C, a forward operating engine 1200 creates a rotary motion with variable timing. FIG. 12A illustrates an example of the system. Multiple cores 1202, made up of SMAs, are connected to a flat plane 1204 and a curved surface 1206 on either end via two roller bearings 1208. As fluid from a hot supply is fed to one of the cores, an endothermic phase transformation occurs causing it to contract and sweep down the curved surface 1206, moving along the flat plane 1204 as it travels. The mechanical motion may then be translated into energy for alternative use.

Once flushed with fluid from a cold supply, the core or cores 1202 will expand, undergoing an exothermic transformation, and continue on the curved surface 1206 path. The timing of the system can be controlled by adjusting the slope and path of the curved surface 1206.

In one embodiment, the mechanism can be implemented in the system in the following manner (shown in FIG. 12B). The flat plane 1204 is in the shape of a circle, whereby the connected roller bearings 1208 are on a track around the perimeter. The curved plane 1206 is in the shape of a circle, parallel and concentric to the flat plane 1204, whereby the connected roller bearings 1206 are on a track around the perimeter. As the cores 1202 expand and contract and sweep across the planes, rotary motion is created.

The system may also be oriented in the horizontal position (FIG. 12C), such that the cores 1202 can be submerged in a reservoir 1210 containing a hot supply, while the cores 1202 that are not submerged are able to cool by either a cold supply or ambient conditions.

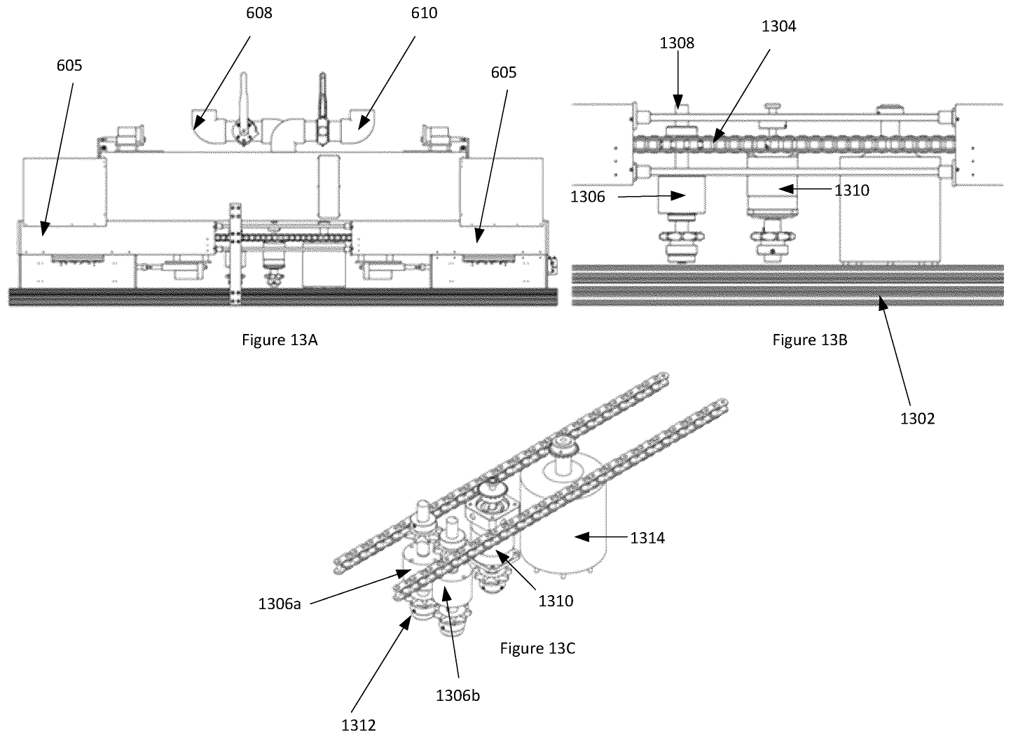

FIGS. 13A to 13C illustrate a further embodiment of a device that operates in the method described in FIG. 7. FIG. 13A shows the system 1300, with a hot supply 608, cold supply 610, reservoirs, two cores 605 and two core outlet valves as described previously, as well as an energy conversion assembly 1302. FIG. 13B is a close-up of the energy conversion assembly 1302, which includes two SMA cores 605 connected by two parallel chains 1304 that reciprocate as the cores 605 are cycled with the hot supply 608 and cold supply 610. Each of the parallel chains 1304 connect to a one-way bearing 1306 via a bearing input shaft 1308. In the current embodiment, the system includes two one-way bearings 1306 and two bearing input shafts 1308. Each one-way bearing connects to a planetary gearbox 1310 via a bearing output shaft 1312 such that the system includes two bearing output shafts.

In the current embodiment, when the bearing input 1308 shaft rotates clockwise, torque is transferred to the bearing output shaft 1312 rotating it in the clockwise direction as well. When the bearing input shaft 1308 rotates counter-clockwise, the bearing output shaft 1312 remains stationary or may rotate clockwise. The direction of torque transfer may be reversed by flipping the one-way bearing orientation. This rotary motion from the bearing output shaft 1312 has a high torque and low speed relative to the generator, as the work output from the SMA core is at a relatively high force but low displacement. The planetary gearbox 1310 is used to increase the speed and decrease the torque to supply the generator 1314. The planetary gearbox 1310 connects to the bearing output shaft via a bearing-gearbox chain (not shown), and connects to the generator via a gearbox-generator chain (not shown).

When the reciprocating chain moves to the left, one of the one-way bearing transfers torque while the other one-way bearing spins freely (FIG. 13C). When the reciprocating chain moves to the right, the second one-way bearing transfers torque while the first one-way bearing spins freely. One way bearings operate in such a way that they only engage when turning in one direction and spin free in the other direction of rotation. The operation of the one-way bearings described above allows the bearing output shafts, planetary gearbox and generator to always rotate in one direction.

In an alternative, the SMA cores may be connected directly to either a barrel cam or crank shaft, which converts the reciprocating motion to one-way rotary motion to power a generator. These types of embodiments can simplify the energy conversion assembly, and reduce the overall mechanical losses of the system.

In some of the embodiments described above, the flow may be continuous across the SMA core, where hot and cold fluid medium, such as, but not limited to, water, are seamlessly switched from their respective sources to the appropriate core, whereas in other embodiments, valves may be utilized to control flow. As described with regard to FIG. 7, the engine may include reservoir outlet valves and/or core outlet valves. Examples of valves are described below.

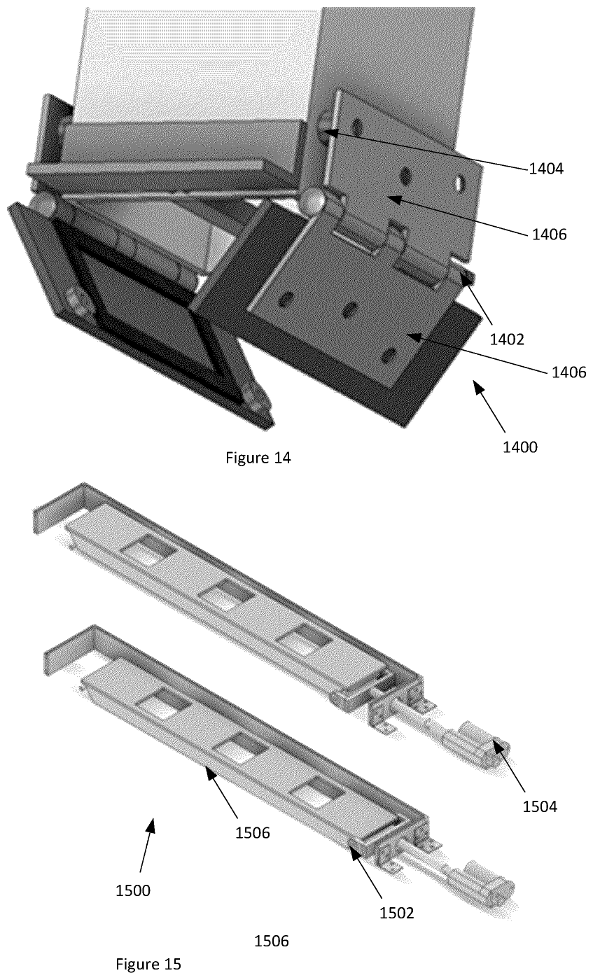

FIG. 14 illustrates an embodiment of a valve 1400 that operates using a spring-loaded hinge 1402 and a magnet 1404. The spring-loaded hinge 1402 and magnet 1404 keep the valve gates 1406 sealed against the core when it is empty (not shown). As the core fills with fluid, the strength of the magnet 1404 is strong enough to keep the valve gates 1406 closed. To open the valve, a pulse of current is applied to the magnet 1404, resulting in a reduced magnetic force allowing the weight of the fluid to open the valve gates 1406. Once fluid is emptied from the core, the spring-loaded hinge 1402 begins to close the valve gates 1406 and the magnetic force will increase as it approaches the core.

In alternative design, an actuator, such as a linear actuator or solenoid, may be used in place of the magnet to keep the valve gates closed.

FIG. 15 illustrates an embodiment of a valve 1500 that utilizes two rollers 1502 and a linear actuator 1504 to open and close. The valve body 1506 rests on the two rollers 1502, one 1502a of which is fixed and the other 1502b connected to the linear actuator 1504. When the linear actuator 1504 extends (FIG. 15A), the valve body 1506 rolls over the fixed roller 1502 and rises, closing the valve. When the linear actuator 1504 contracts (FIG. 15B), the valve body 1506 rolls back over the fixed roller 1502a and lowers, opening the valve. An advantage of this design is that very low friction is experienced by the valve.

In an alternative, the resistivity of the SMA core may be measured and used as feedback to a control loop for the valves such as those shown in FIGS. 14 and 15. By measuring the resistivity of the SMA, an amount of strain and the stage of the phase transformation can be inferred (as described in, for example, U.S. Pat. No. 11,215,170 entitled Shape Memory Alloy Actuator with Strain Gauge Sensor and Position Estimation and Method for Manufacturing same issued Jan. 4, 2022 which is hereby incorporated by reference). The control loop can act to ensure that the valves do not flush the core until full phase transformation is achieved to maximize, increase and/or improve work output and system efficiency. In this case, it may be preferable to flush the core at an intermediate stage where only partial transformation has occurred to reduce the cycle time (i.e. finding a balance between cycle time and amount of transformation to optimize or improve power output).

In a further alternative, the water, or fluid, level in the core may be measured and used as feedback to a control loop for the valves. A water, or fluid, level sensor may be utilized to provide input to the control loop. In one embodiment, a valve including a float connected to a flapper valve by a chain (similar to that used in a toilet tank) may be used when the fluid is a liquid such that once the liquid reaches a certain height the chain pulls upward and opens the flapper to drain the core. When the liquid in the core is below the maximum, or a predetermined, height, the pressure of the liquid keeps the flapper valve closed. This design can be advantageous in that it requires no electrical input and does not rely on a control loop.

In some cases, a siphon (similar to that used in a toilet bowl) may be used in place of a valve when the fluid is a liquid such that once the core (or reservoir) fills to a predetermined level and there is a sufficient amount of liquid in the siphon tube, a pressure differential is created whereby the core is at a higher pressure relative to the siphon tube, causing it to suck, or pull the liquid out of the core. This can be advantageous in that it also does not require electrical input and does not rely on a control loop.

For some embodiments herein that utilize antagonistic SMA cores, the valves can be timed such that one SMA core is almost always exposed to fluid from a hot supply, so that there is never a downtime where both SMA cores are fully martensite and not outputting any work.

For embodiments herein that have multiple cascading SMA cores, the cycle time for each level of the cascade may differ, therefore more or less of the respective hot or cold source may come directly from the hot supply or cold supply, rather than from the previous level of the cascade, such that no single level of the cascade is a limiting factor for the cycle time of the overall SMA core system.

Various embodiments herein include an SMA that may include any one of, or combination of, the following general forms of SMA: rods—straight SMA wires; springs—SMA wire wound into a helical spring form; sheets—thin sheets of SMA; foam—porous SMA structure; or a combination of any of the above; or the like.

In the case of springs, winding the SMA into a spring form can have the advantage of reducing the strain of the SMA core, which offers the benefit of an improved cycle life. In an alternative design, rather than a standard round wire, the springs may be wound from a wire with a polygon shape to optimize and/or improve the stress distribution from winding. The method for fabricating an SMA spring may include a multi-stage winding process designed to reduce internal stresses and breakage during manufacture.

In some cases, the wire goes through an initial winding stage, whereby the diameter of the mandrel on which it is wound is sufficiently higher than the desired final diameter of the spring. In the next stage, the wire wrapped on the mandrel can be exposed to a heat treatment to set the shape into the wire. These two processes may be repeated multiple times with decreasing mandrel diameters, until a desired spring diameter is achieved. This process may be expedited by heating at stages throughout the process, whereby the wire is wound on a mandrel in a tube and exposed to heating, such as inductive heating, to locally heat the wire to extreme temperatures. In this case, this simultaneously heats the wire to remove cold working (to make the wire less brittle and more workable before winding), and maintains the heat during winding so that the wire can shape set to its wound state. The speed at which the mandrel turns and the wire feeds into the tube can be adjusted to achieve the desired properties.

In the case of sheets, the sheets may be further cut to achieve specialized geometries using, for example, a high precision energy source (i.e. a femtosecond laser), or electrical discharge machining (EDM), minimizing, or reducing the heat affected zone and preserving desired material properties. As an example, the SMA core described for the design disclosed in FIG. 3 may be cut to have perforations to enable the SMA to engage with the bearings via some form of protrusions, such as gear teeth, to prevent, or reduce, slippage of the SMA core. In an alternative design, sheets may be cut into two-dimensional (2D) springs to minimize, or reduce, strain during actuation, similar to the principles described for the wire spring form.

In the case of foam, a porous SMA structure can increase the surface area of the core, providing advantages such as, but not limited to, improved surface area to volume ratio and therefore reducing thermal gradients and local stress gradients promoting a longer lifecycle and uniform force application by the SMA leading to higher power output.

Since the SMA core can include multiple SMAs in the desired form, each individual SMA may be configured to the same desired length such that the entire bundle of SMAs behaves in the same manner to maximize, improve or increase force output and balance internal stresses. The SMA may be laser marked in-situ during processing to precisely mark the cutting location, and alternatively may be, for example, laser cut (depending on the form) to automate this process.

In order to mount the SMA core to the engine, the ends of the SMA core may be crimped. The crimps may be made of metal, preferably stainless steel to avoid and/or reduce, corrosion. In an alternative design, the crimps may be made of a shape memory alloy, either the same or very similar to the SMA core material, and the shape memory effect may be utilized in, for example, the following manner: the crimp may be cooled to below its martensitic start temperature, for example around or below 0° C., to deform the material and increase the diameter of an inner crimping hole. Next, the SMA core can be inserted, and the assembly is subsequently heated to above room temperature (if the austenitic finish temperature is above room temperature), causing the crimp to return to its original shape and contracting the inner crimping hole to apply a crimping force on the SMA core.

In another alternative, crimps may be artificially made from the SMA core itself, whereby a high energy source is applied to the end of the wire to create a molten melt pool that solidifies into a free air ball, creating a mechanical fastener/crimp. In situations where using crimps occupies more surface area than is allowable, other options may be used. In some cases, free air balls can be made by melting the end of the wire to make it larger, so it is unable to pass through a connection hole or the like, creating a mechanical fastener. This method allows the SMA to transmit the force to the connecting rods and allows for greater packing density within the core. In another variation, wire swaging may be used. In this case, SMA material/wires can be pressed into a die to deform them into a flattened cross section that prevents, or reduces, pull through a smaller opening. The wire holes may be drilled to a smaller diameter such that the larger major diameter of the swaged wire provides a stop where the wire cannot be pulled through.

In another design, the SMA may be secured through welding, using nickel or the SMA material itself as a filler material.

In another implementation, a larger mechanical swage can be formed by peening the end of the SMA wire to create the enlarged end to prevent, or reduce, pull through the smaller drilled hole in the plate that is being used to support the SMA wires.

Another implementation can have the SMA secured using a silver-alloy based brazing material and appropriate flux for nickel and titanium alloys.

In another design, the SMA may be looped around such that the two ends may be secured on one side using one of the previously disclosed methods. For example, if both ends are secured to a plate, on one side, the SMA would loop through two separate holes in the plate, and on the other, the two ends would either loop through the same hole or two separate holes and be secured using one of the methods described above.

If the SMA core form is a sheet, the sheet may be cut into a geometry that allows the ends to mechanically lock into place, also reducing the need for an additional crimp.

In one example, each SMA may be individually crimped and mounted to the engine, whereas in another example, multiple SMAs may be affixed to a securement method, be it a single crimp, weld joint, or brazed joint.

To maximize, or increase, the strength of the crimp and improve cycle life, the section of the SMA core that interfaces with the crimp may remain austenite, while selected portions of the remainder of the core will be martensite from laser processing as disclosed above, resulting in a hybridized structure.

Embodiments herein have discussed various configurations in which the SMA materials are biased antagonistically by other SMA materials. However, other options may include biasing using a deadweight; biasing using a spring; biasing antagonistically, using a crankshaft; or the like.

The supporting plate which has been drilled to allow the SMA wires to pass through and is supporting the mechanical fastened wire can also be modified in some implementations. This could include having a softer interlayer on the surface of the plate, such as brass or other deformable metal, which allows the fastening method, e.g. a free air ball, swage or peened end, to deform the plate and create more surface area to support the wire fastening.

As the methods for converting SMA motion to rotary motion mentioned above may be used to power a generator, some embodiments may be used directly for electricity generation.

In one embodiment for electricity generation, the system may include a linear alternator, which is a generator that works from linear, reciprocating motion as opposed to rotary motion. In these linear alternators, movement can be driven by the SMA core.

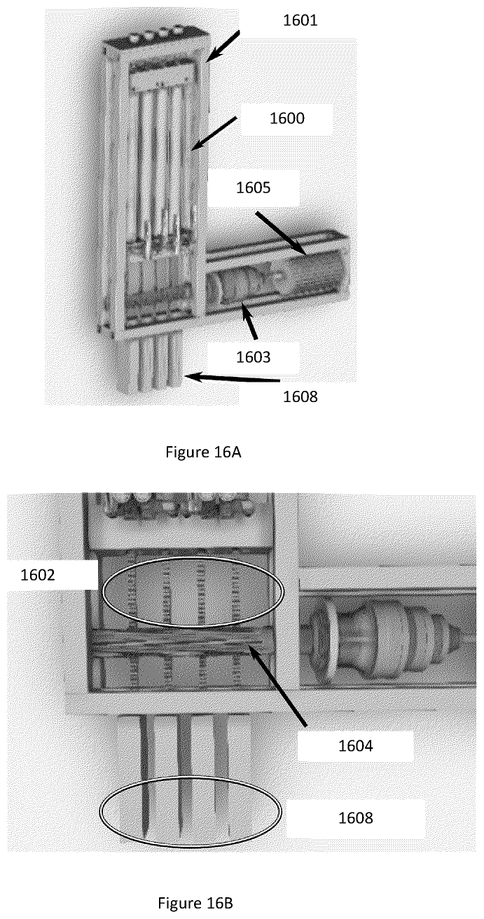

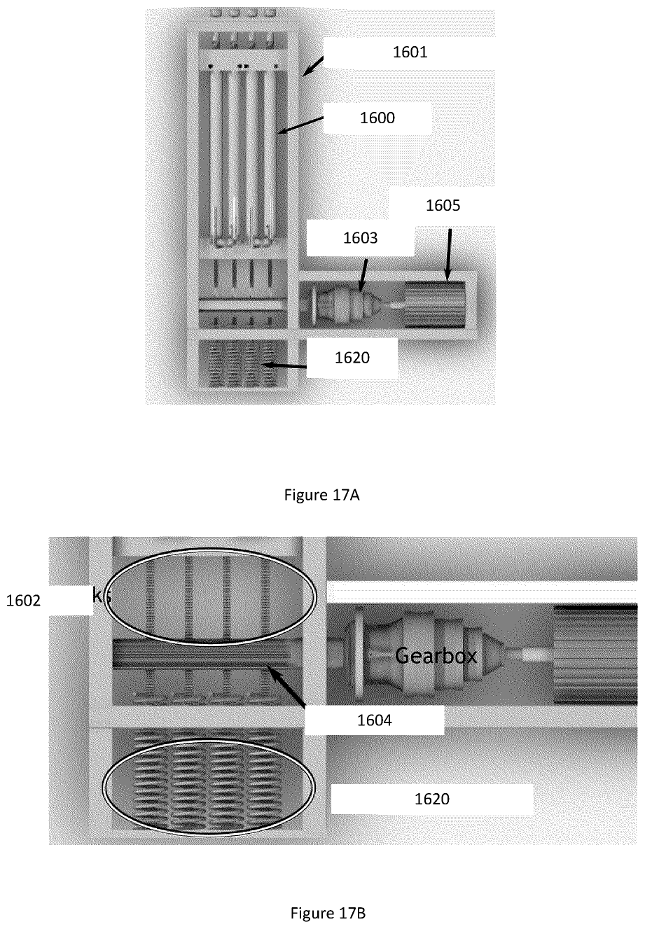

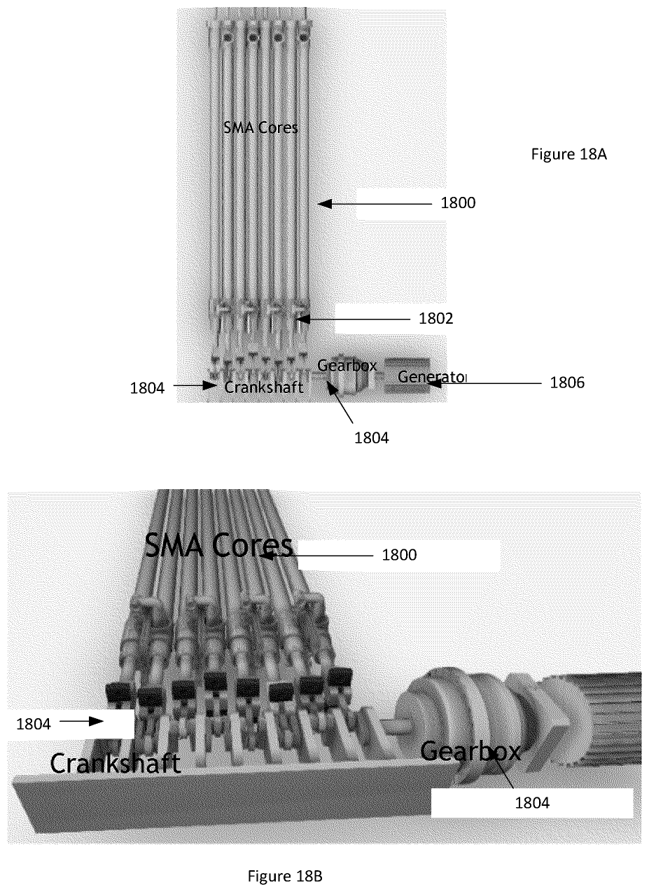

In biasing with a deadweight, as shown in FIGS. 16A and 16B, one or more SMA cores 1600 (located within a support frame 1601) can be connected to a gear rack 1602, which can be meshed with a pinion gear 1604 connected to a generator 1605 via a gearbox 1603. In this case, core movement can be unidirectional through two one-way bearings. This allows two one-way bearings to be positioned in opposite orientation to spin the generator when descending and ascending. In this configuration, a hot source, such as hot water causes the SMA core to contract against the deadweight 1608 while a cold source, such as cold water relaxes the SMA and the deadweight biases and resets the core.

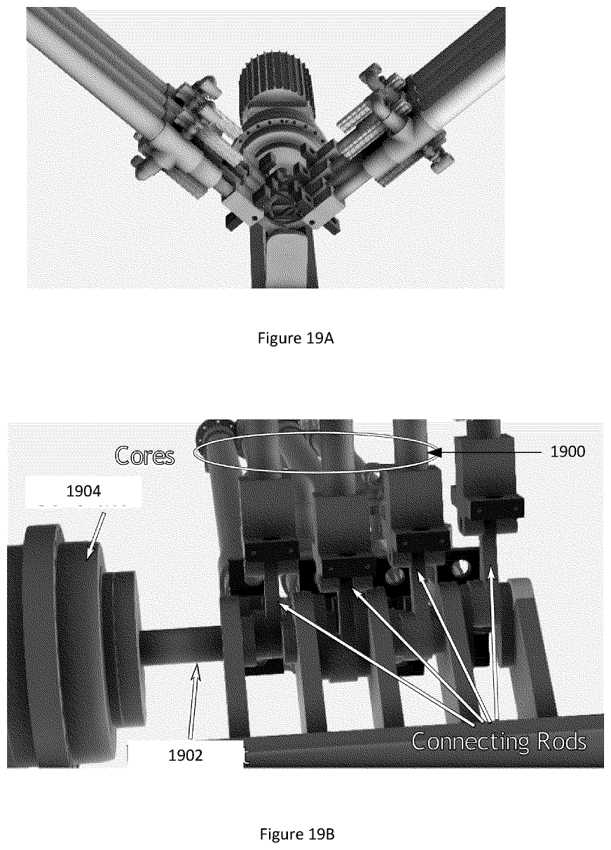

Biasing with a spring is somewhat similar, as shown in FIGS. 17A and 17B, except deadweights are replaced by springs 1620.

When using a crankshaft, operation is similar to that in, for example, a car. SMA cores that are “opposite” are connected to crank shoulders on opposite ends of the shaft. Contraction on one side, causes extension of the core connected to the opposite shoulder. This arrangement can allow for inline or V orientation.

For an inline crankshaft, as shown in FIGS. 18A and 18B, a single SMA core 1800 is connected to each crank shoulder using connecting rods 1802. In an antagonistic SMA core design, opposing SMA cores may be connected to shoulders that are 180 degrees opposed on the crankshaft 1804. The SMA core timing may be accomplished using valving or the like. The crankshaft 1804 can be directly connected to a gearbox 1806, then to a generator 1808.

For a V shaped crankshaft, such as a “V8” crankshaft, as shown in FIGS. 19A and 19B, SMA cores 1900 can be connected with one antagonistic pair to a shoulder. Timing can be sequenced using, for example, an SMA linked valve design. Each core pair can be sequenced by aligning the SMA-linked valve at timings that correspond to 90° out of phase on the crankshaft 1902. The output of the crankshaft 1902 can be connected to a gearbox, then a generator 1904 as in other designs. The V-shape can be made to accommodate any number of cores, through using a crankshaft with a plurality of shoulders. It is possible for each shoulder on the crank shaft to be connected to a single SMA core or multiple SMA cores.

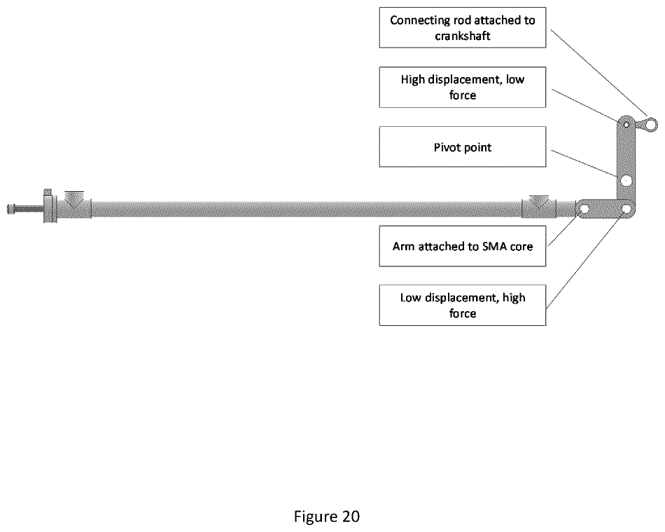

As a further embodiment, such as shown schematically in FIG. 20, it is possible to increase leverage and displacement for a bigger stroke by connecting the SMA core to the connecting rod using a lever 2000. The lever 2000 includes a set of holes enabling the lever to be connected to a crankshaft and the SMA core. One advantage of this embodiment is to allow freedom to match any stroke of a crankshaft with a fixed SMA length by altering pivot point location. This arrangement can also help in converting force to displacement, reducing the total force seen by the crankshaft. Properties and characteristics of the lever are shown in FIG. 20.

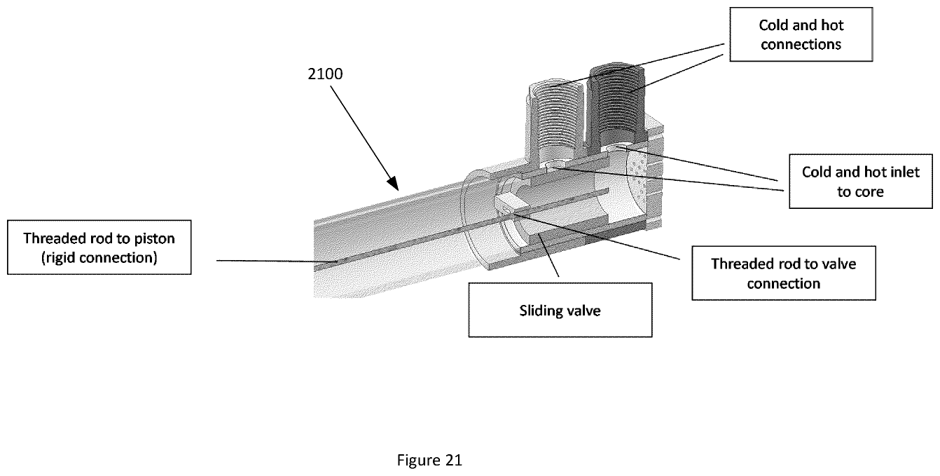

The valves used with the SMA core can also be of various types. One embodiment is illustrated in FIG. 21, in which a valve 2100 can be rigidly connected to a piston. As the piston moves, the movement automatically causes the valve to open/close the correct hot/cold inlets (connected to the hot and cold supplies) allowing the respective fluid medium to pass through the valve.

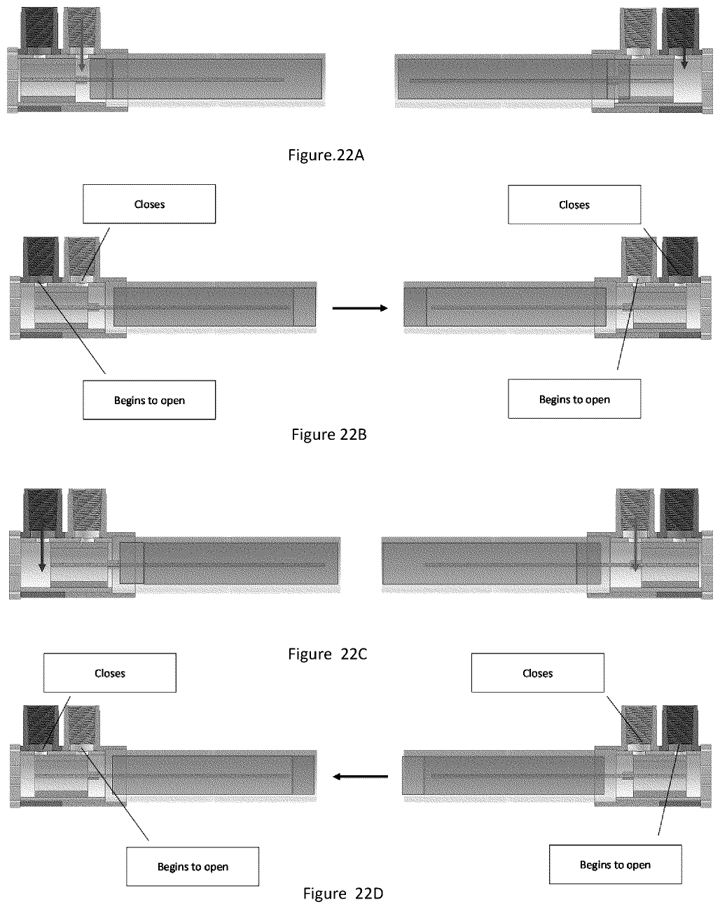

In one embodiment of operation of the piston in FIG. 21 is illustrated in FIGS. 22A to 22D. A starting point, as shown in FIG. 22A where: the piston has just moved left, there is hot water in the left core, and cold water in the right core. The cold inlet associated with the left core or reservoir is then opened allowing fluid from the cold supply to enter the left core, and the hot inlet associated with the right core or reservoir is opened allowing fluid from the hot supply to enter the right core. In FIG. 22B, the piston begins to move to the right. In FIG. 22C, the piston has just moved to the right and the hot inlet associated with the left core or reservoir is then opened allowing fluid from the hot supply to enter the left core, and the cold inlet associated with the right core or reservoir is opened allowing fluid from the cold supply to enter the right core. In FIG. 22D, the piston moves to the left to begin the cycle again. It is understood that the terms “right” and “left” are being used to describe the operation with respect to FIGS. 22A to 22D and that in operation, the piston moves in opposite directions and not necessarily right and left. For example, it may be up and down if the cores are vertical with respect to each other.

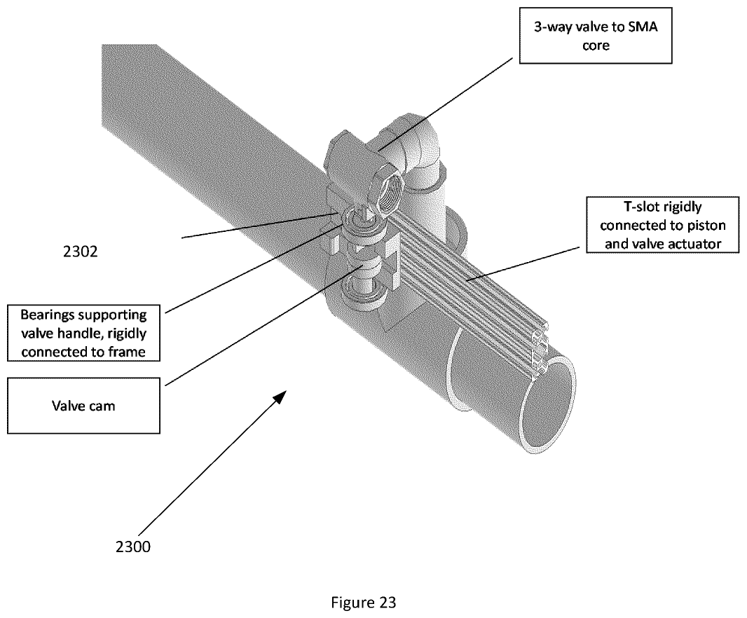

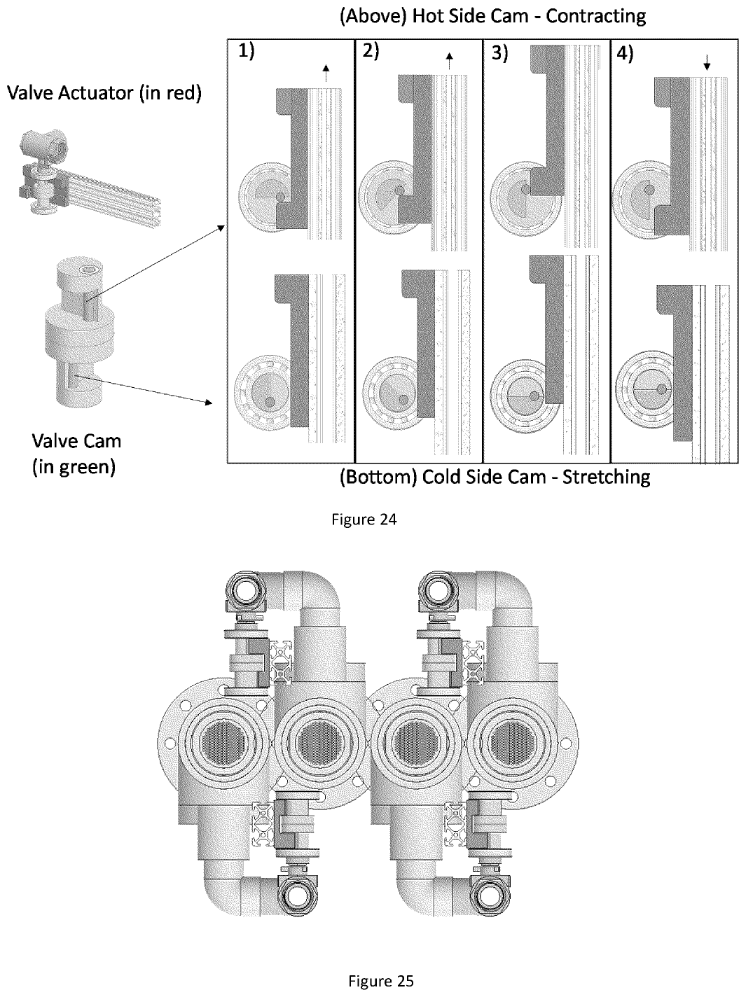

Another embodiment of a valve may include a three-way valve activated by an SMA core. FIG. 23 illustrates an example of this type of valve 2300. In this embodiment, a connection between the valve and the SMA core is made, for example with a T-slot connected to an SMA core piston where the T-slot has a valve actuator 2302 connected to it. The valve actuator is connected to a three-way valve. As the SMA core actuates, the T-slot moves with the actuator pushing against a valve cam, causing it to rotate. The valve cam has two identical halves that are rotated out of phase from each other. The operation is illustrated in further detail in FIG. 24.

At (1), the actuator moves up with SMA core motion whereby the top actuator makes contact with the valve cam and the bottom misses. At (2), the top cam making contact rotates, causing the bottom cam to also rotate thereby changing a position of the 3-way valve. At (3), the SMA core completes a stroke, linked to actuator (red) and the top and bottom cams are fully rotated. At (4), the core starts to move downwards, with bottom cam in position to make contact, and top cam will miss the actuator.

A three-way valve can be provided on each core as illustrated in FIG. 25. Each core can have a three way valve that is actuated with the SMA core position. This arrangement eliminates, or reduces, the need for timing and increases robustness towards changes in flow rates or temperatures which affect timing. This valve can be used on both the inlet and/or the outlet valves of the cores.

Another embodiment of the valve could be a multi-core valve design, such as, for example, a 4-way valve. The operation of the valve could be common as either supply or outlet, or both. The body of the valve could be common to both the hot and cold supplies. This body could serve as a manifold to, for example, four (4) cores. In one specific embodiment, a diverter rotates in the interior of the manifold, bent in a flattened S profile such as via a toothed connection, or through another mechanical connection. This flattened S isolates the fluid flow on the bottom of the manifold from that on the top, allowing for two different temperature fluids to be separated and directed to the desired core. Another embodiment of this diverter could include more complex geometries for a third or more fluid isolation and directing to multiple cores. In particular, fluid flow can be inlet to the manifold from the connections on top and bottom and the diverter rotates. This allows the two separated flows to be directed to different cores out of phase with each other, in accordance with the desired operation of the heat engine.

In some embodiments, the valves may be hydraulically or pneumatically actuated. Pressurization of the pneumatic or hydraulic fluid may be achieved through SMA actuation, such as by, but not limited to, pumping gas or liquid into a reservoir or being directly applied to the valve or other actuator.

In some embodiments, it may also be possible to alter the properties of the SMA materials. As one example, it may be possible to increase the copper (Cu) composition of the SMA material (typically NiTi). Copper content/composition can be increased by, for example: (1) make a solution of sulfuric acid and methanol with a Cu and NiTi electrode; (2) use an electric current to disassociate Cu from a Cu electrode, and deposit it onto surface of an NiTi electrode; (3) and use a laser or other high energy source to melt the surface Cu into the bulk of the NiTi. This process may also be used with other SMA alloys, such as AICuNiTi, NiTiHf, or other compositions.

Lasers may also be used to treat the SMA material in other ways. For example, laser processing can be performed on the base SMA material (e.g. NiTi metal) to cause reformation in the SMA material with a reduction of undesired intermetallic species, reduction of surface defects, evaporation of impurities or the like. Such treatments can lead to increased life cycle and work output of the SMA material. Still further, laser processing can imbue the SMA with multiple memories. Multiple memories can allow for creating a cascade of different transition temperatures to extract heat as the fluid medium moves through the core. Multiple memories can also allow for a more effective and efficient actuation—as the fluid medium cools down, more of the SMA becomes engaged.

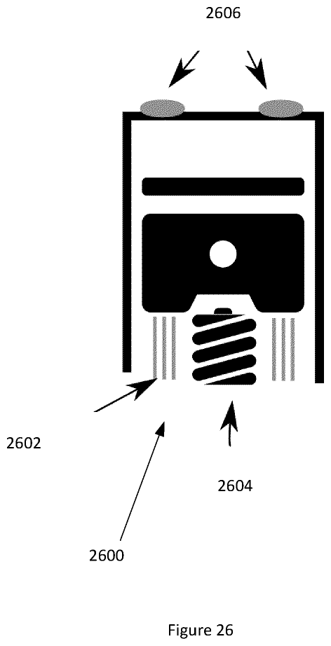

SMA materials/cores can be used as heat engines in the forward direction in other applications. As illustrated in FIG. 26, an SMA based compressor 2600 or pump can make use of some similar elements/principles to those described above. For example, an SMA material/core 2602 can be used to retract a piston while a biasing spring 2604 is used to provide the compression. In this case, inlet and outlet valves 2606 control the air flow rate.

In one embodiment of operation, the SMA core below the piston is heated, such as by methods taught above, and the inlet air valve opened; inlet air valve is closed; cold fluid floods the bottom of the piston, with both gas valves closed; the gas is compressed by a biasing spring; the outlet valve is opened and the compressed gas leaves the cylinder; the cycle repeats. This arrangement can be used for compression of a refrigeration cycle, heat pump, air compressor, fluid pump or the like.

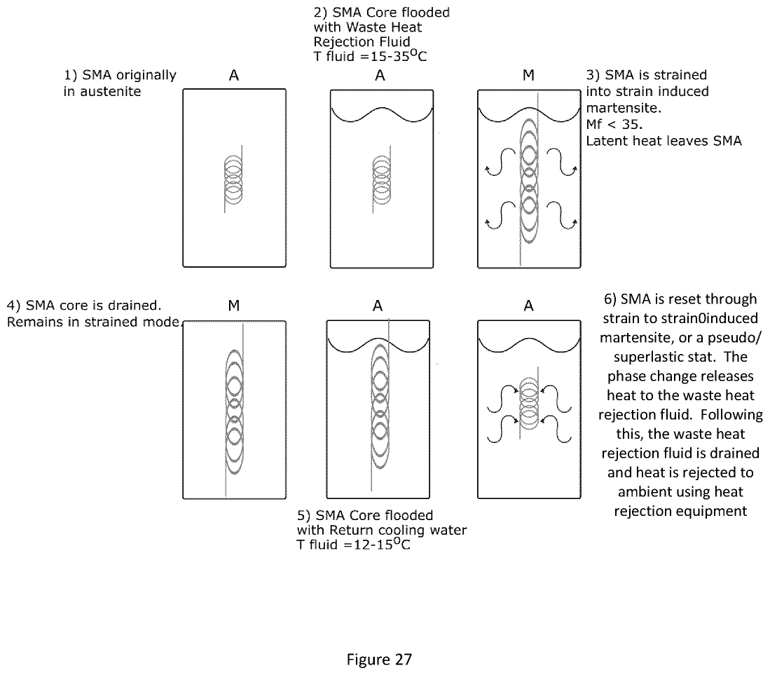

In an example of using SMA material/core in refrigeration or a heat pump as a heat engine operating in reverse, FIG. 27 illustrates the use of SMA material/core as a refrigerant. Initially the SMA core is in an austenite state. Cycling the water or heat medium moves the heat from a hot reservoir into a cold reservoir, or vice-versa depending on the tuning of the transition temperatures.

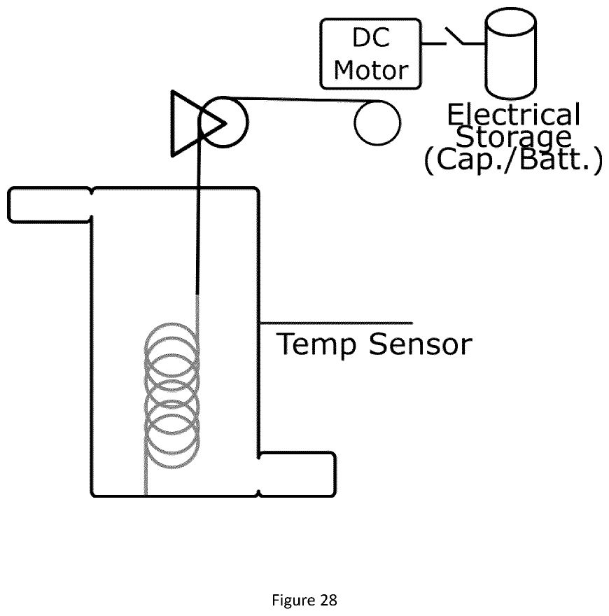

In one embodiment, the cycle, or process, may be as follows: (1) the SMA material is originally in its austenite form. (2) The SMA core is flooded with a heat rejection fluid (liquid or gas). (3) The SMA core is subjected to a strain to induce the exothermic phase transformation to martensite. (4) The fluid medium is changed, with the SMA core remaining in the strained state. (5) The SMA core is flooded with the cooling medium. (6) The SMA is released from strain, causing it to undergo the endothermic phase transformation, absorbing heat from its environment, and reducing the temperature. An embodiment of this type of system is illustrated in FIG. 28. In particular, an electric motor can be used to strain the SMA from austenite (A) to martensite (M). Upon the switch from M to A later in the cycle, the motor can act as a generator and recover some of the mechanical work, converting the mechanical work to electricity to off-set the next cycle. This allows for a more efficient process overall.

Another embodiment of the heat engine in the reverse direction could use two antagonistically paired SMA cores. One core would be used in place of the motor to contract strain the opposite core, to provide the mechanical motion, as opposed to a motor. This would increase the cooling capacity and allow the chiller to operate from waste heat.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether aspects of the embodiments described herein are implemented as a software routine, hardware circuit, firmware, or a combination thereof.

Embodiments of the disclosure or portions/aspects thereof may be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A heat engine comprising:
at least one shape memory alloy (SMA) core;
wherein when the at least one SMA core is exposed to at least two different temperatures, the SMA core expands and contracts during exposure to generate mechanical motion within the at least one SMA core.

2. The heat engine of claim 1 further comprising a generator or linear alternator for capturing the mechanical motion and translating the mechanical motion into energy.

3. The heat engine of claim 1 further comprising a gearbox connecting the at least one SMA core to the generator.

4. The heat engine of claim 1 further comprising:
a hot supply for supplying a hot medium to the at least one SMA core; and
a cold supply for supplying a cold medium to the at least one SMA core.

5. The heat engine of claim 1 wherein the at least one SMA core comprises a SMA belt, SMA rods, SMA wires, SMA springs, SMA sheets or SMA in a foam form.

6. The heat engine of claim 1 further comprising a reservoir for housing the at least one SMA core.

7. The heat engine of claim 6 wherein the at least one SMA core comprises a pair of SMA cores.

8. The heat engine of claim 7 wherein the reservoir comprises a first section for housing a first SMA core and a second section for housing a second SMA core.

9. The heat engine of claim 8 wherein the first section comprises an inlet connected to a hot supply for receiving a hot medium.

10. The heat engine of claim 8 wherein the first and second sections each comprise a hot supply inlet valve for receiving a hot medium and a cold supply inlet valve for receiving a cold medium.

11. The heat engine of claim 10 further comprising a controller for filling the first section with the hot medium and the second section with the cold medium and then filling the first section with the cold medium and the second section with the hot medium.

12. The heat engine of claim 1 wherein the at least one SMA core is processed via multiple memory material technology.

13. The heat engine of claim 1 comprising four SMA cores that are radially connected.

14. The heat engine of claim 13 further comprising a set of four reservoirs for housing each of the four SMA cores, each of the set of reservoirs including at least one inlet valve for receiving fluid for heating or cooling the four SMA cores.

15. The heat engine of claim 14 wherein an inlet valve for one of the reservoirs is connected to an outlet valve of another reservoir.

16. The heat engine of claim 1 wherein the at least one SMA core comprises:
a set of three bearings in a delta configuration;
a reservoir for housing two of the set of three bearings; and
a SMA belt wrapped around the set of three bearings;
wherein the two of the set of three bearings are exposed to a different temperature than the other of the set of three bearings.

17. The heat engine of claim 16 further comprising an idler pulley located connected to the other of the set of three bearings and wherein the SMA belt wraps around the set of three bearings and the idler pulley.

18. The heat engine of claim 17 wherein the idler pulley comprises two pulleys of unequal radii.

19. The heat engine of claim 1 wherein the at least one SMA core comprises at least one bundle of SMA wires.

20. The heat engine of claim 19 wherein ends of the SMA wires are crimped or swaged with SMA material.

21. The heat engine of claim 1 wherein the heat engine is integrated with a valve that is actuated by the at least one SMA core.

22. A refrigeration device comprising:
at least one shape memory alloy (SMA) core;
wherein when the at least one SMA core is placed under strain to induce the exothermic phase transformation and then released from strain to undergo an endothermic phase transformation.

23. The heat engine of claim 20 wherein the ends of the SMA wires are locally heat treated before or after being crimped or swaged.

24. The heat engine of claim 1 comprising at least one valve actuated by a hydraulic or pneumatic system charged directly by SMA actuation.
